(19) United States
(12) Patent Application Publication
(10) Pub. No.: US 2016/0223480 A1
(43) Pub. Date: Aug. 4, 2016

(54) SAMPLE VIAL FOR CALORIMETRIC MEASUREMENTS

(71) Applicant: SYMCEL SVERIGE AB, Kista (SE)

(72) Inventors: Magnus JANSSON, Bromma (SE); Christer WALLIN, Spånga (SE)

(73) Assignee: SYMCEL SVERIGE AB, Kista (SE)

(21) Appl. No.: 15/021,896

(22) PCT Filed: Aug. 20, 2014
(86) PCT No.: PCT/SE2014/050951

§ 371 Date: Mar. 14, 2016

(30) Foreign Application Priority Data
Sep. 30, 2013 (SE) 1351139-9

(51) Int. Cl. G01N 25/48; B01L 3/00

(52) U.S. Cl. CPC G01N 25/486; B01L 3/508; B01L 2300/04; B01L 2300/0835; B01L 2300/168

(57) ABSTRACT

A sample vial for calorimetric measurements is of low mass, and the vial is at least partially coated with an infrared reflective coating on the outside of the vial. A lid is adapted to form an ampoule together with the vial.

### FIELD OF INVENTION

The present invention relates to a sample vial for calorimetric measurements and a lid for the vial.

### DESCRIPTION OF BACKGROUND ART

Isothermal calorimetry measurements are typically performed in equipment using single sample chambers individually insulated and thermo stated. In order to increase throughput of sample handling and adapting to common laboratory inventory a single plate multi-channel isothermal calorimeter using one common chamber for multiple sample vials can be used. This allows a faster and more efficient sample throughput in the typical laboratory environment.

### SUMMARY OF THE PRESENT INVENTION

### Problems

The size restrictions imposed by using a standardized microtiter plate layout, such as described in Standard; ANSI/SBS 1-2004, places the heat producing sample vials in close proximity to each other and to the neighboring heat flow sensors. The insulation between individual samples of the microtiter plate will be through air.

Infrared based heat radiation between samples poses the risk of inducing undesired cross sample heating and loss of sample accuracy.

### Solution

From the standpoint of a sample vial for calorimetric measurements and with the purpose of solving one or more of the above mentioned problems, the present invention teaches that the vial material is of low mass, and that the vial is at least partially coated with an infrared reflective coating on the outside of the vial.

By utilizing a sample vial material of low mass a fast heat transfer will occur from sample vial to the heat flow sensor. Coating of the sample vial with and infrared reflective coating will reflect produced heat in the vial back into the vial as well as deflecting heat produced in adjacent vials. The net result is increased integrity of the specific sample signal in a multi vial isothermal calorimeter.

It is proposed that the vial material includes, but is not limited to, titanium alloys, and that the infrared reflective coating includes, but is not limited to, titanium nitride.

When utilizing a principle where heat flow is measured transferring energy from the sample vial, flowing to a heat sink mounted sensor, through a side of the vial in contact with the sensor, it is proposed that this side of the vial is free from infrared reflective coating to increase heat flow to the thermal sensor. It is proposed that the bottom of the vial is the side of the vial in contact with the sensor located in the bottom of the sample assembly.

The infrared reflective coating is preferably mechanically stabile and chemically of high inertia, e.g. Gold (Au) or ceramic compounds including, but not limited to, titanium nitride (TiN), such as BALINIT® A from Oerlicon Balzers, and it is proposed to use a coating thickness between 0,5 μm and 4 μm.

With the purpose of providing a complete ampoule with the advantageous properties of the inventive vial the present invention also relate to a lid adapted to form an ampoule together with an inventive vial. The lid material is of low mass, and that the lid is at least partially coated with an infrared reflective coating on the outside of the lid.

The lid material includes, but is not limited to, titanium alloys, and the infrared reflective coating includes, but is not limited to, titanium nitride.

The infrared reflective coating is mechanically stabile and chemically of high inertia, such as Gold (Au) or ceramic compounds including, but not limited to, titanium nitride and has a coating thickness between 0,5 μm and 4 μm.

### Advantages

The advantages of a vial or a method according to the present invention is that the net result is increased heat transfer inter vial from sample to sensor via selective application of infrared reflective material on the vial sides excluding the side of the vial in contact with the sensor.

The inventive sample vial is specifically advantageous for use in multi-channel calorimetric measurements since the intra sample infrared radiation is reduced by minimizing through air heat radiation to the adjacent vials and sensors.

### BRIEF DESCRIPTION OF THE DRAWINGS

A samples vial according to the present invention will now be described in detail with reference to the accompanying drawings, in which:

FIG. 1 is a cross sectional view of an inventive sample vial with a lid,

FIG. 2 is a schematic simplified cross sectional enlarged view of a part of a vial with a coating, and

FIG. 3 is a schematic simplified cross sectional enlarged view of a part of a lid with a coating.

### DESCRIPTION OF EMBODIMENTS AS PRESENTLY PREFERRED

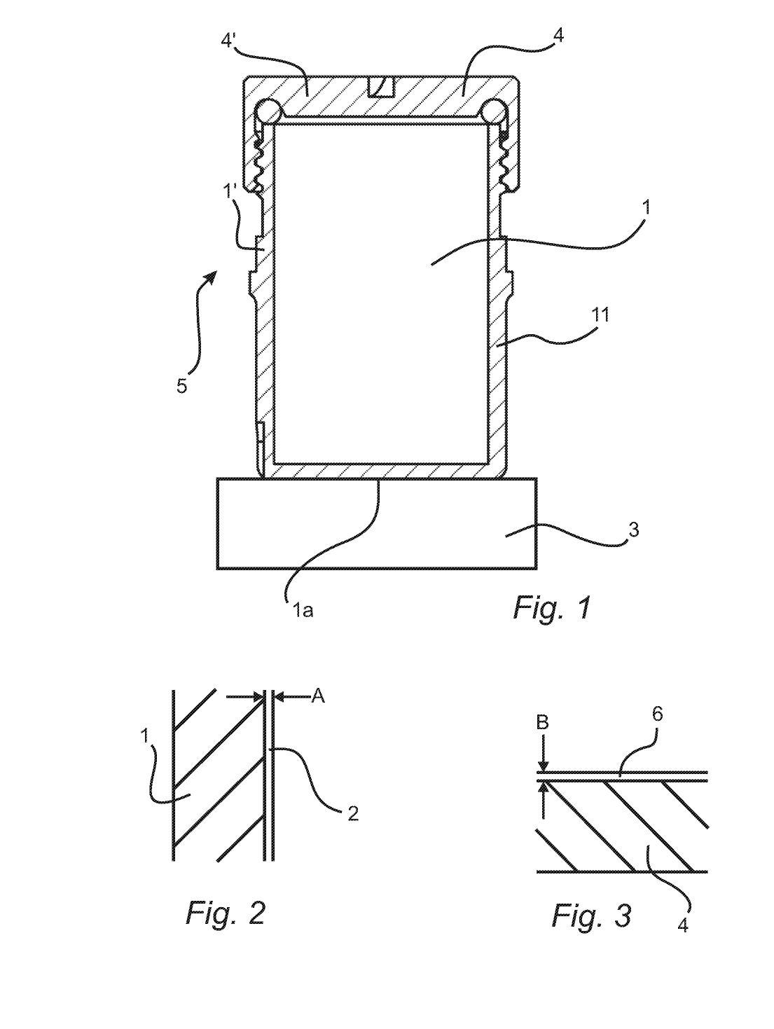

The present invention will now be described with reference to FIG. 1 showing a sample vial 1 for calorimetric measurements where the vial material 1′ is of low mass. FIG. 2 shows that the vial 1 is at least partially coated with an infrared reflective coating 2 on the outside of the vial 1.

The vial is adapted to measurements where heat flow is measured transferring energy from the vial 1, flowing to a heat sink mounted sensor 3, through one side la of the vial in contact with the sensor 3, and it is proposed that this side la of the vial is free from infrared reflective coating. FIG. 1 shows an embodiment where the bottom of the vial 1 is the side la of the vial in contact with the sensor 3.

It is proposed that the vial material 1′ includes, but is not limited to, titanium alloys, and that the infrared reflective coating 2 includes, but is not limited to, titanium nitride.

Preferably the infrared reflective coating 2 is mechanically stabile and chemically of high inertia, such as Gold (Au) or ceramic compounds including, but not limited to, titanium nitride.

It is also proposed that the infrared reflective coating has a coating thickness A between 0,5 μm and 4 μm. FIG. 1 also shows a lid 4 adapted to form an ampoule 5 together with an inventive vial 1. The lid material 4′ is of low mass, and FIG. 3 shows that the lid 4 is at least partially coated with an infrared reflective coating 6 on the outside of the lid 4.

The lid material 4′ includes, but is not limited to, titanium alloys, and the infrared reflective coating 6 includes, but is not limited to, titanium nitride.

The infrared reflective coating 6 is mechanically stabile and chemically of high inertia, such as Gold (Au) or ceramic compounds including, but not limited to, titanium nitride and has a coating thickness B between 0,5 μm and 4 μm.

It will be understood that the invention is not restricted to the aforedescribed and illustrated exemplifying embodiments thereof and that modifications can be made within the scope of the invention as defined by the accompanying Claims.

1. A sample vial for calorimetric measurements, wherein the vial material is of low mass, and that wherein the vial is at least partially coated with an infrared reflective coating on the outside of the vial.

2. The vial according to claim 1, wherein the vial is adapted to measurements where heat flow is measured transferring energy from the vial, flowing to a heat sink mounted sensor, through one side of the vial in contact with the sensor, and wherein the one side of the vial is free from the infrared reflective coating.

3. The vial according to claim 2, wherein a bottom of the vial is the side of the vial in contact with the sensor.

4. The vial according to claim 1, wherein the vial material includes, but is not limited to, titanium alloys.

5. The vial according to claim 1, wherein the infrared reflective coating includes, but is not limited to, titanium nitride.

6. The vial according to claim 1, wherein the infrared reflective coating is mechanically stabile and chemically of high inertia.

7. The vial according to claim 6, wherein the infrared reflective coating is made out Gold (Au) or ceramic compounds including, but not limited to, titanium nitride.

8. The vial according to claim 1, wherein that the infrared reflective coating has a coating thickness between 0.5 μm and 4 μm.

9. A lid adapted to form an ampoule together with the vial according to claim 1, wherein the lid material is of low mass, and wherein the lid is at least partially coated with an infrared reflective coating on an outside of the lid.

10. The lid according to claim 9, wherein the lid material includes, but is not limited to, titanium alloys.

11. The lid according to claim 9, wherein the infrared reflective coating includes, but is not limited to, titanium nitride.

12. The lid according to claim 9, wherein the infrared reflective coating is mechanically stabile and chemically of high inertia.

13. The lid according to claim 12, wherein the infrared reflective coating is made out Gold (Au) or ceramic compounds including, but not limited to, titanium nitride.

14. The lid according to claim 9, wherein the infrared reflective coating has a coating thickness between 0.5 μm and 4 μm.

15. The vial according to claim 2, wherein the vial material includes, but is not limited to, titanium alloys.

16. The vial according to claim 3, wherein the vial material includes, but is not limited to, titanium alloys.

17. The vial according to claim 2, wherein the infrared reflective coating includes, but is not limited to, titanium nitride.

18. The vial according to claim 3, wherein the infrared reflective coating includes, but is not limited to, titanium nitride.

19. The vial according to claim 4, wherein the infrared reflective coating includes, but is not limited to, titanium nitride.

20. The vial according to claim 2, wherein the infrared reflective coating is mechanically stabile and chemically of high inertia.
